(19) United States
(12) Patent Application Publication
(10) Pub. No.: US 2014/0297527 A1
(43) Pub. Date: Oct. 2, 2014

(54) SYSTEM AND METHOD FOR LOCATION BASED VALIDATION VIA MOBILE DEVICE

(71) Applicant: BOTTOMLINE TECHNOLOGIES (DE) INC., Portsmouth, NH (US)

(72) Inventors: Brian Smith MCLAUGHLIN, Hampton, NH (US); Gareth Rory PRIEST, Newfields, NH (US); Eric CAMPBELL, Rye, NH (US)

(73) Assignee: Bottomline Technologies (DE) Inc., Portsmouth, NH (US)

(21) Appl. No.: 13/854,181

(22) Filed: Apr. 1, 2013

(51) Int. Cl. G06Q 20/32

(52) U.S. Cl. CPC G06Q 20/3224
USPC 705/44

(57) ABSTRACT

A system and method is presented for approving or disapproving a transaction requested by an initiating device based on a physical location of a mobile device associated with a user relative to a physical location of the initiating device. A user attempting to perform a sensitive action at an initiating device provides user data to the initiating device. After validating the user data, the system determines a mobile device associated with the user. In order to confirm the user data, the system determines a location of the initiating device relative to a location of the associated mobile device. If the mobile device is within a predefined proximity of the initiating device, the received user data is confirmed as valid and the transaction is approved.

### TECHNICAL FIELD

The present invention relates to fraud prevention, verification of user identity, and more particularly, to a system and method for validating a transaction based on the location of a mobile device associated with a user relative to the location of the transaction.

### BACKGROUND OF THE INVENTION

In the United States, consumers, banks, and merchants lose hundreds of billions of dollars per year due to credit card fraud. Despite the increasing number of individuals performing sensitive actions using electronic means (e.g., paying for goods using credit cards, opening checking accounts online, etc.), fraud prevention has failed is to significantly improve the reliability of user identification. For example, a consumer using a credit card in a store is only required to physically present the credit card and provide a signature in order to complete a purchase. There exists a need for a system or method that improves user authentication.

### SUMMARY OF THE INVENTION

The present invention provides a system and method for approving or disapproving a transaction requested by an initiating device based on a physical location of a mobile device associated with a user relative to a physical location of the initiating device.

A first aspect of the present invention relates to a method for approving or disapproving a transaction requested by an initiating device based on a physical location of a mobile device associated with a user relative to a physical location of the initiating device. The method includes receiving, over a network, user data from the initiating device. The user data includes data necessary to initiate the transaction. The method also includes determining a validity of the received user data by comparison with saved data stored in a database. If the received user data is determined valid, the method determines the physical location of the initiating device relative to the physical location of the mobile device associated with the user, identifies the user data as confirmed valid if the physical location of the initiating device relative to the physical location of the mobile device is within a predefined proximity, and identifies the user data as unconfirmed if the physical location of the initiating device relative to the physical location of the mobile device is not within the predefined proximity. The method further includes approving the transaction if the user data is confirmed valid.

Additionally or alternatively, if the user data is identified as unconfirmed, the method includes requesting user confirmation, on the mobile device, of the transaction and approving the transaction if the user of the mobile device confirms the transaction.

Additionally or alternatively, the method also includes disapproving the transaction if the user of the mobile device does not confirm the transaction.

Additionally or alternatively, determining the physical location of the initiating is device relative to the physical location of the mobile device includes determining the physical location of the initiating device, determining the physical location of the mobile device, and determining a distance between the physical location of the initiating device and the physical location of the mobile device.

Additionally or alternatively, the physical location of the initiating device relative to the physical location of a mobile device is within the predefined proximity if the distance between the physical location of the initiating device and the physical location of the mobile device is less than the predefined proximity.

Additionally or alternatively, the predefined proximity is a distance selected from a range of 50 yards to 5 miles.

Additionally or alternatively, the physical location of at least one of the initiating device and the mobile device is determined using a hardware location device.

Additionally or alternatively, the hardware location device comprises at least one of a global positioning system receiver, a Global Navigation Satellite System device, a Galileo positioning system device, a Compass navigation system device, and an Indian Regional Navigational Satellite System device.

Additionally or alternatively, the hardware location device is a component of at least one of the mobile device and the initiating device.

Additionally or alternatively, the physical location of at least one of the initiating device and the mobile device is determined using at least one of an IP address, cellular triangulation, multilateration of radio signals, and Wi-Fi triangulation.

Additionally or alternatively, determining a physical location of the initiating device relative to a physical location of the mobile device includes detecting a connection between the initiating device and the mobile device.

Additionally or alternatively, the connection includes at least one of a Bluetooth connection, a physical connection, a Wi-Fi connection, a radio frequency identification (RFID) connection, and an infrared connection.

Additionally or alternatively, an identifier of the mobile device associated with the user is stored in the database.

Additionally or alternatively, the mobile device is a mobile phone.

Additionally or alternatively, the transaction is an electronic monetary transaction.

Additionally or alternatively, the electronic monetary transaction is a credit card transaction, an ATM transaction, and/or a debit card transaction.

Additionally or alternatively, the transaction is a transaction affecting a user's credit rating and/or a user's bank account.

Additionally or alternatively, the transaction is a request to open a credit card and/or obtain a loan.

Another aspect of the present invention relates to a system for approving or disapproving a transaction requested by an initiating device based on a physical location of a mobile device associated with a user relative to a physical location of the initiating device. The system includes a network interface and a processor. The network interface is configured to receive, from the initiating device, user data necessary to initiate the transaction. The processor is configured to determine a validity of the received user data by comparison with saved data stored in a database encoded to a non-transitory computer readable medium. If the received user data is determined valid, the processor is also configured to determine a physical location of the initiating device relative to the physical location of the mobile device associated with the user, identify the user data as confirmed valid if the physical location of the initiating device relative to the physical location of the mobile device is within a predefined proximity, and identify the user data as unconfirmed if the physical location of the initiating device relative to the physical location of the mobile device is not within the predefined proximity. The processor is further configured to approve the transaction if the user data is confirmed valid.

Additionally or alternatively, if the user data is identified as unconfirmed, the network interface is further configured to send a request to the mobile device requesting user confirmation of the transaction and receive, from the mobile device, user confirmation or user disapproval of the request. The processor is further configured to approve the transaction if the network interface receives user confirmation of the transaction.

Additionally or alternatively, the processor is further configured to disapprove the transaction if the network interface receives user disapproval of the transaction.

Additionally or alternatively, approving the transaction if the user data is confirmed valid further comprises the network interface sending an approval of the transaction to the initiating device.

Another aspect of the present invention relates to a server configured for approving or disapproving a transaction requested by an initiating device based on a physical location of a mobile device associated with a user relative to a physical location of the initiating device. The server includes a network interface and a processor. The network interface is configured to receive, from the initiating device, user data necessary to initiate the transaction. The processor is configured to determine a validity of the received user data by comparison with saved data stored in a database encoded is to a non-transitory computer readable medium. If the received user data is determined valid, the processor is also configured to determine a physical location of the initiating device relative to the physical location of the mobile device associated with the user, identify the user data as confirmed valid if the physical location of the initiating device relative to the physical location of the mobile device is within a predefined proximity, and identify the user data as unconfirmed if the physical location of the initiating device relative to the physical location of the mobile device is not within the predefined proximity. The processor is further configured to approve the transaction if the user data is confirmed valid.

A number of features are described herein with respect to embodiments of the invention; it will be appreciated that features described with respect to a given embodiment also may be employed in connection with other embodiments.

For a better understanding of the present invention, together with other and further aspects thereof, reference is made to the following description, taken in conjunction with the accompanying drawings. The scope of the invention is set forth in the appended claims, which set forth in detail certain illustrative embodiments. These embodiments are indicative, however, of but a few of the various ways in which the principles of the invention may be employed.

### BRIEF DESCRIPTION OF THE DRAWINGS

FIG. 1 is an exemplary diagram of operation of a transaction approval system;

FIG. 2 is a block diagram representing the architecture of the transaction approval system in accordance with an exemplary embodiment of the present invention;

FIG. 3 is a block diagram depicting a request for user confirmation of a transaction;

FIG. 4 is a flow chart representing operation of a method of approving a transaction a user in accordance with an exemplary embodiment of the present invention; and

FIG. 5 is a flow chart representing a particular embodiment of FIG. 4.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present invention provides a system and method for approving or disapproving a transaction requested by an initiating device (e.g., a cash register including a credit card reader) based on a physical location of a mobile device associated with a user relative to a physical location of the initiating device. A user attempting to perform a sensitive action (e.g., make a purchase using a credit card) at an initiating device provides user data to the initiating device. After validating the user data (e.g., credit card number and card security code), the system determines a mobile device (e.g., a mobile phone) associated with the user. In order to confirm the user data, the system determines a location of the initiating device relative to a location of the associated mobile device. If the mobile device is within a predefined proximity of the initiating device, the received user data is confirmed as valid and the transaction is approved (e.g., the credit card purchase is approved). If the mobile device is not within the predefined proximity of the initiating device, the user data is identified as invalid and, e.g., the user may be requested to approve the transaction through a notification on the mobile device.

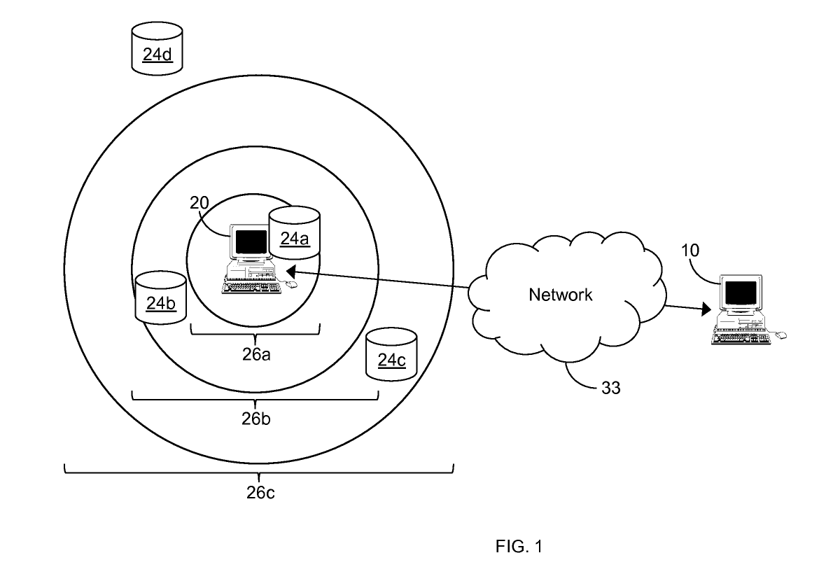

Turning to FIG. 1, operation of the transaction approval system 10 is depicted with a mobile device 24 located at four different locations, represented by mobile devices 24a-24d. The initiating device 20 provides user data to the system 10. After validating the received user data, the system 10 attempts to confirm the validity of the user data. If the physical location of the initiating device 20 relative to the physical location of the mobile device 24 is within a predefined proximity 26, the system 10 identifies the user data as confirmed valid. For example, for a predefined proximity 26a, of the four depicted mobile device locations, the system 10 only confirms the user data when the mobile device 24 is positioned as depicted by mobile device 24a. That is, at the positions represented by mobile devices 24b-24d, the mobile device 24 is not within the predefined proximity 26a, and therefore, the user data would not be confirmed. However, for a larger predefined proximity 26b, the user data would also be confirmed if the mobile device 24 is positioned as mobile devices 24aand 24b. Similarly, for a still larger predefined proximity 26c, the mobile device 24 positioned as mobile devices 24cis also within the predefined proximity 26c.

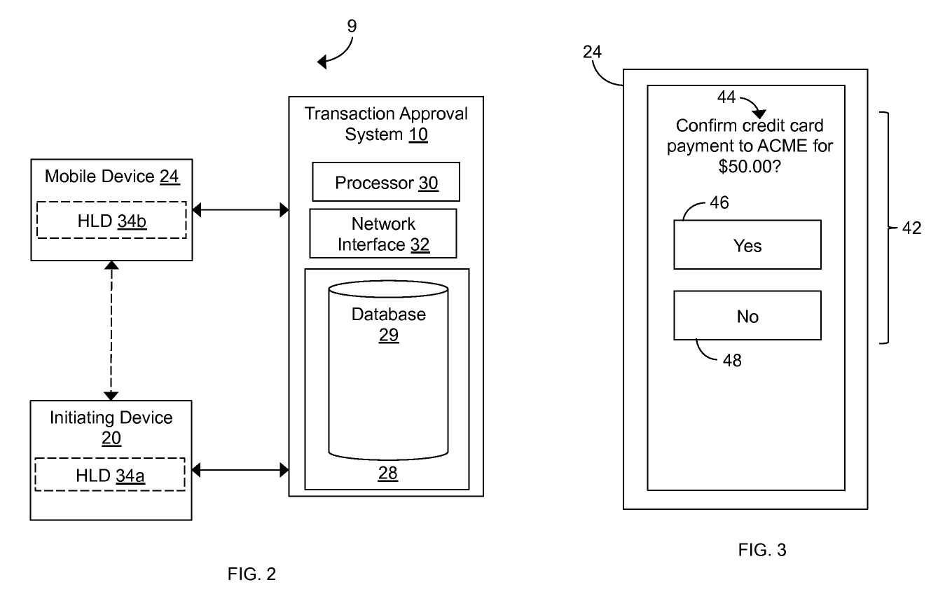

An exemplary architecture 9 including a transaction approval system 10, an initiating device 20, and a mobile device 24 is depicted in FIG. 2. The system 10 may be a computer system of one or more computers or servers including at least a processor 30, a network interface 32, and computer readable medium 28. The computer readable medium 28 may include encoded thereon a database 29. The database 29 may include data structures, also referred to as tables, as described herein and may include instructions embodied on computer readable medium 28 for interfacing with the network interface 32 and for reading and writing data to the database 29.

The transaction approval system 10, initiating device 20, and mobile device 24 may be communicatively coupled over a network 33, e.g., an open network (such as the Internet), a private network (such as a virtual private network), or any other suitable network. The network interface 32 of the system 10 may be configured to receive user data from the initiating device 20, request a physical location of the initiating device 20 relative to a physical location of the mobile device 24, receive the physical location of the initiating device 20 relative to the physical location of the mobile device 24, send a request to the mobile device requesting user confirmation of the transaction, receive a user confirmation or user disapproval of the request, and/or sending an approval of the transaction to the initiating device if the user data is confirmed valid or user approval of the transaction is received.

As will be understood by one of ordinary skill in the art, the network interface 32 may comprise a wireless network adaptor, an Ethernet network card, or any suitable device that provides an interface between the system 10 and the network 33.

The processor 30 may be configured to (1) validate the user data, (2) determine a mobile device 24 associated with the user, (3) identify the user data as confirmed valid if a physical location of the initiating device relative to a physical location of the mobile device is within an allowable proximity, (4) approve the transaction if user confirmation of the transaction is received, and/or (5) disapprove the transaction if user disapproval of the transaction is received.

As will be understood by one of ordinary skill in the art, the processor 30 may have various implementations. For example, the processor 30 may include any suitable device, such as a programmable circuit, integrated circuit, memory and I/O circuits, an application specific integrated circuit, microcontroller, complex programmable logic device, other programmable circuits, or the like. The processor 30 may also include a non-transitory computer readable medium, such as random access memory (RAM), a read-only memory (ROM), an erasable programmable read-only memory (EPROM or Flash memory), or any other suitable medium. Instructions for performing the method described below may be stored in the non-transitory computer readable medium and executed by the processor 30. Based on this disclosure, one of ordinary skill in the art would understand how to program the processor 30 to perform the steps described herein.

The processor 30 may validate the user data received by the network interface 32 by comparing the user data to saved user data stored in the database 29. The saved user data may be stored in the database 29 as plain text, encrypted text, the output of a hash function with or without salting, or in any other suitable manner. The database 29 may also store an identification of a mobile device 24 associated with each saved data. The identification of each mobile device may comprise a telephone number, an Internet protocol (IP) address, a media access control (MAC) address, a unique device identifier, or any other suitable means for identifying a device. The processor 30 may determine the mobile device 24 associated with a user by accessing the mobile device identifier associated with the saved user data matching the user data.

As will be understood by one of ordinary skill in the art, the database 29 may describe a data structure which embodies groups of records or data elements stored in a volatile or non volatile storage medium and accessed by an application, which may be instructions coded to a storage medium and executed by a processor. The database 29 may comprise multiple individual databases stored on the same storage medium or on multiple different storage media. The system 10 may also store data in and access the database 29. While the database 29 is depicted as a component of the system 10 in FIG. 1, the database 29 could alternatively be stored on a separate server.

The processor 30 is further configured to determine a physical location of the initiating device 20 relative to a physical location of the mobile device 24. Determining the relative physical location of the initiating device 20 and the mobile device 24 may comprise determining the physical location of the initiating device 20, determining the physical location of the mobile device 24, and determining a distance between the physical location of the initiating device 20 and the physical location of the mobile device 24. Determining the physical location of the initiating device 20 and/or the mobile device 24 may comprise the system 10 requesting the initiating device 20 and the mobile device 24 for their physical location. For example, the physical location of the initiating device 20 and/or the mobile device 24 may be determined using a hardware location device 34. The hardware location device may be a component of the mobile device 24 and/or the initiating device 20.

The hardware locating device 34 may provide a longitude and latitude for the initiating device 20 or mobile device 24. For example, the hardware location device may be a global positioning system (GPS) receiver, a Global Navigation Satellite System device, a Galileo positioning system device, a Compass navigation system device, an Indian Regional Navigational Satellite System device, or any other suitable device. Upon receiving the system's request for a physical location, the initiating device 20 and/or mobile device 24 may provide the system 10 the physical location based on the output of the hardware locating device 34.

Alternatively, as opposed to a hardware locating device 34, the physical location of the initiating device 20 and the mobile device 24 may be determined using an IP address, cellular triangulation, multilateration of radio signals, Wi-Fi triangulation, lookup table containing a known location of the initiating device, or using any other suitable means. For example, for controllers of the initiating device (e.g., a brick and mortar merchant) having a verified address, the location of the initiating device 20 may be obtained by using a look up table (e.g., stored in the database 29) to determine the verified address of the initiating device 20.

The distance between the physical location of the initiating device 20 and the physical location of the mobile device 24 may include calculating the distance (e.g., the Euclidian distance or great circle distance) between the latitude and longitude coordinates of the initiating device 20 and the latitude and longitude coordinates of the mobile device 24.

If the distance between the physical location of the initiating device 20 and the physical location of the mobile device 24 is less than the predefined proximity, the processor 30 may validate the user data. The physical location of the initiating device 20 relative to the physical location of a mobile device 24 is within the predefined proximity if the distance between the physical location of the initiating device 20 and the physical location of the mobile device 24 is less than the predefined proximity. The predefined proximity may be a fixed distance (e.g., a distance selected from the range is of 50 yards to 5 miles) or a variable distance. The predefined proximity may vary based on how the physical location of the initiating device 20 and mobile device 24 was determined. For example, if a GPS device was used to determine the position of both the initiating device 20 and the mobile device 24, the predefined distance may be 100 yards. Alternatively, if the IP address of the initiating device 20 or the mobile device 24 was used to determine the distance between the devices, the predefined distance may be 5 miles. The predefined proximity may also vary based on the location of the initiating device 20. For example, if the user is located in a large city where it is possible to more accurately determine physical location based on IP address, the predefined proximity may be 0.5 miles.

The predefined proximity may also vary based on the requested transaction. For example, the transaction may be a transaction affecting a user's credit rating and/or a user's bank account (e.g., an electronic monetary transaction), such as a credit card transaction, an ATM transaction, a debit card transaction, a request to open a credit card, and/or a request to obtain a loan. If the user is attempting to make a relatively small purchase using a credit card, the predefined proximity may be larger than if the user is attempting to obtain a new credit card. Alternatively, the predefined proximity may be a user defined value or a system defined value.

As opposed to determining the physical location of the initiating device 20 and the mobile device 24, the system 10 may detect, as an indication of the relative physical location of the mobile device 24 to the initiating device 20, a connection between the initiating device 20 and the mobile device 24. That is, the system 10 may detect, e.g., a limited range connection between the initiating device 20 and the mobile device 24. For example, the connection may be a Bluetooth connection, a physical connection (e.g., a USB connection), a Wi-Fi connection, a radio frequency identification (RFID) connection, an infrared connection, or any other suitable connection. Based on the limited range of the connection, it can be assumed that, if there is a connection between the initiating device 20 and the mobile device 24, the initiating device 20 and the mobile device 24 are within a limited distance of one another. Thus, after receiving a request for the physical location, the initiating device 20 and/or the mobile device 24 may inform the system 10 that the two devices 20, 24 share a connection. Based on this information, the processor 30 may confirm the user data.

The initiating device 20 may comprise a cash register, credit card reader, personal computer, tablet computer, smart phone, or any other device suitable for initiating the transaction. As indicated previously the initiating device 20 may include a hardware locating device 32 for determining the physical location of the device 20. The initiating device 20 may additionally include hardware and/or software for communicating and interfacing with the system 10.

The mobile device 24 may comprise a cellular phone, smart phone, tablet computer, or any other suitable device. As indicated previously the mobile device 24 may include a hardware locating device 32 for determining the physical location of the device 24. The mobile device 24 may additionally include hardware and/or software for communicating and interfacing with the system 10.

Turning to FIG. 3, if the physical location of the mobile device 24 relative to the physical location of the initiating device 20 is not within the predefined proximity, the system 10 may request user confirmation of the transaction on the mobile device 20. The mobile device 24 may display a request for confirmation 42 including a query 44 and response options 46, 48. For example, the query 44 may identify the type of transaction (e.g., credit card), a merchant (e.g., ACME) attempting to initiate the transaction, and specify a transaction amount (e.g., $50.00). The response options may be “yes” 46 or “no” 48. If the user of the mobile device 24 confirms the transaction (e.g., selects “yes” 46), the transaction may be approved. Alternatively, if the user of the mobile device 24 does not confirm the transaction (e.g., by selecting “no” 48 or failing to enter a response), the transaction may be disapproved (e.g., the transaction does not take place).

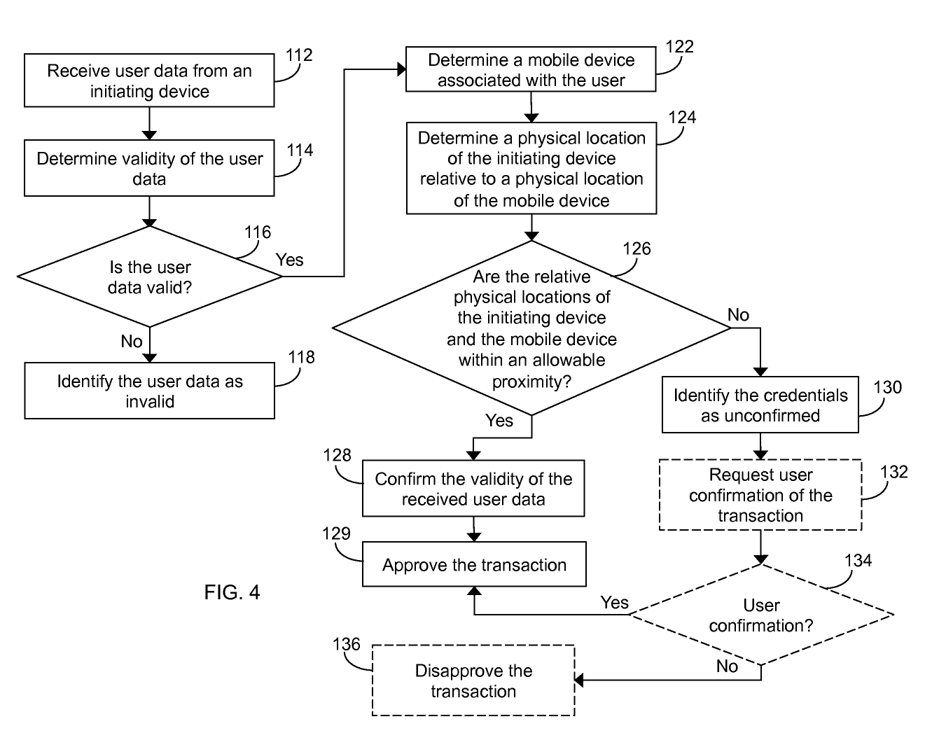

Turning to FIG. 4, exemplary steps of a method for approving or disapproving the transaction requested by the initiating device is shown. The steps may be performed, e.g., in response to a request from an initiating device 20. The request may comprise, e.g., a user attempting to perform a sensitive action, such as make an electronic payment (e.g., make a purchase using a credit card) or obtain a loan. In process block 112, the system 10 receives user data (i.e., data necessary to initiate the transaction) over the network 33. User data may comprise credit card information, address information, name, social security number, etc. For example, a user may swipe a credit card through a credit card reader and the credit card reader (i.e., the initiating device 20) may provide credit card information (i.e., user data) contained in the magnetic strip of the credit card to the system 10. In process block 114, the system 10 determines a validity of the user data by comparison with saved user data stored in a database. Determining the validity of user data may be performed using any suitable means known to a person of ordinary skill in the art. In decision block 116, if the user data is invalid, the user data is identified as invalid in process block 118. If the user data is identified as invalid, the transaction may be disapproved.

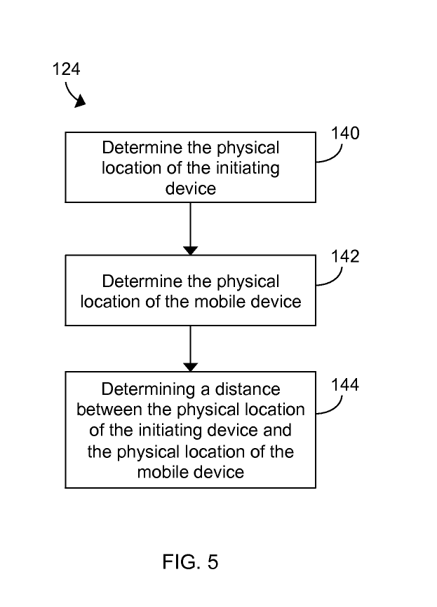

Alternatively, in process block 122, if the user data is identified as valid in decision block 116, the system 10 determines a mobile device 24 associated with the user. Determining the associated mobile device 24 may comprise accessing the database 29 to determine the mobile device identifier that is stored with the saved user data matching the received user data. In process block 124, the system 10 determines the physical location of the initiating device 20 relative to a physical location of the associated mobile device 24. As described previously, determining the physical location of the initiating device 20 relative to the physical location of the associated mobile device 24 may comprise detecting a connection between the initiating device 20 and the associated mobile device 24 or determining a distance between the devices 20, 24 as described in FIG. 5 below. In decision block 126, if the physical location of the initiating device 20 relative to the physical location of the mobile device 24 is within a predefined proximity, the validity of the user data is confirmed in process block 128. If the user data is identified as confirmed valid, in process block 130, the transaction is approved. Approval of the transaction may include the system 10 sending an approval signal to the initiating device 20 to perform the transaction.

Alternatively, if the physical location of the initiating device relative to the physical location of the mobile device is not within the predefined proximity or cannot be determined to be within the predefined proximity, the user data is identified as unconfirmed in process block 130. In optional process block 132, if the user data is identified as unconfirmed, the system 10 may request user confirmation of the transaction. As depicted in FIG. 3, the request for user confirmation may comprise a request for confirmation 42 displayed on the mobile device 24. In optional process block 134, if the user confirms the transaction (e.g., by selecting “yes” 46 to confirm the transaction in FIG. 3), the transaction may be approved in process block 129. Alternatively, in optional process block 136, if the user does not confirm the transaction (e.g., by selecting “no” 48 in FIG. 3 or failing to select “yes” 46 or “no” 48), the transaction may be disapproved.

Turning to FIG. 5, one embodiment of determining a physical location of the initiating device 20 relative to a physical location of the mobile device 24 is described. In process block 140, the system 10 determines the physical location of the initiating device 20. In process block 142, the system 10 determines the physical location of the mobile device 24. In process block 144, the system determines a distance between the physical location of the initiating device 20 and the physical location of the mobile device 24.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A method for approving or disapproving a transaction requested by an initiating device based on a physical location of a mobile device associated with a user relative to a physical location of the initiating device, the method comprising:
receiving, over a network, user data from the initiating device, wherein the user data comprises data necessary to initiate the transaction;
determining a validity of the received user data by comparison with saved data stored in a database;
if the received user data is determined valid:
determining the physical location of the initiating device relative to the physical location of the mobile device associated with the user;
identifying the user data as confirmed valid if the physical location of the initiating device relative to the physical location of the mobile device is within a predefined proximity; and
identifying the user data as unconfirmed if the physical location of the initiating device relative to the physical location of the mobile device is not within the predefined proximity; and approving the transaction if the user data is confirmed valid.

2. The method of claim 1, further comprising, if the user data is identified as unconfirmed, requesting user confirmation, on the mobile device, of the transaction and approving the transaction if the user of the mobile device confirms the transaction.

3. The method of claim 2, further comprising disapproving the transaction if the user of the mobile device does not confirm the transaction.

4. The method of claim 1, wherein determining the physical location of the initiating device relative to the physical location of the mobile device comprises:
determining the physical location of the initiating device;
determining the physical location of the mobile device; and
determining a distance between the physical location of the initiating device and the physical location of the mobile device.

5. The method of claim 4, wherein the physical location of the initiating device relative to the physical location of a mobile device is within the predefined proximity if the distance between the physical location of the initiating device and the physical location of the mobile device is less than the predefined proximity.

6. The method of claim 5, wherein the predefined proximity is a distance selected from a range of 50 yards to 5 miles.

7. The method of claim 5, wherein the physical location of at least one of the initiating device and the mobile device is determined using a hardware location device.

8. The method of claim 7, wherein the hardware location device comprises at least one of a global positioning system receiver, a Global Navigation Satellite System device, a Galileo positioning system device, a Compass navigation system device, and an Indian Regional Navigational Satellite System device.

9. The method of claim 7, wherein the hardware location device is a component of at least one of the mobile device and the initiating device.

10. The method of claim 7, wherein the physical location of at least one of the initiating device and the mobile device is determined using at least one of an IP address, cellular triangulation, multilateration of radio signals, and Wi-Fi triangulation.

11. The method of claim 1, wherein determining a physical location of the initiating device relative to a physical location of the mobile device comprises detecting a connection between the initiating device and the mobile device.

12. The method of claim 11, wherein the connection comprises at least one of a Bluetooth connection, a physical connection, a Wi-Fi connection, a radio frequency identification (RFID) connection, and an infrared connection.

13. The method of claim 1, wherein an identifier of the mobile device associated with the user is stored in the database.

14. The method of claim 1, wherein the mobile device is a mobile phone.

15. The method of claim 1, wherein the transaction is an electronic monetary transaction.

16. The method of claim 15, wherein the electronic monetary transaction is a credit card transaction, an ATM transaction, and/or a debit card transaction.

17. The method of claim 1, wherein the transaction is a transaction affecting a user's credit rating and/or a user's bank account.

18. The method of claim 17, wherein the transaction is a request to open a credit card and/or obtain a loan.

19. A system for approving or disapproving a transaction requested by an initiating device based on a physical location of a mobile device associated with a user relative to a physical location of the initiating device, the system comprising:
a network interface configured to receive, from the initiating device, user data necessary to initiate the transaction;
a processor configured to:
determine a validity of the received user data by comparison with saved data stored in a database encoded to a non-transitory computer readable medium;
if the received user data is determined valid:
determining a physical location of the initiating device relative to the physical location of the mobile device associated with the user;
identifying the user data as confirmed valid if the physical location of the initiating device relative to the physical location of the mobile device is within a predefined proximity; and
identifying the user data as unconfirmed if the physical location of the initiating device relative to the physical location of the mobile device is not within the predefined proximity; and
approve the transaction if the user data is confirmed valid.

20. The system of claim 19, wherein if the user data is identified as unconfirmed:
the network interface further configured to send a request to the mobile device requesting user confirmation of the transaction and receive, from the mobile device, user confirmation or user disapproval of the request;
the processor further configured to approve the transaction if the network interface receives user confirmation of the transaction.

21. The system of claim 20, where the processor is further configured to disapprove the transaction if the network interface receives user disapproval of the transaction.

22. The system of claim 19, wherein approving the transaction if the user data is confirmed valid further comprises the network interface sending an approval of the transaction to the initiating device.

23. A server configured for approving or disapproving a transaction requested by an initiating device based on a physical location of a mobile device associated with a user relative to a physical location of the initiating device, the server comprising:
a network interface configured to receive, from the initiating device, user data necessary to initiate the transaction;
a processor configured to:
determine a validity of the received user data by comparison with saved data stored in a database encoded to a non-transitory computer readable medium;
if the received user data is determined valid:
determining a physical location of the initiating device relative to the physical location of the mobile device associated with the user;
identifying the user data as confirmed valid if the physical location of the initiating device relative to the physical location of the mobile device is within a predefined proximity; and
identifying the user data as unconfirmed if the physical location of the initiating device relative to the physical location of the mobile device is not within the predefined proximity; and
approve the transaction if the user data is confirmed valid.
